(19) United States
(12) Patent Application Publication
(10) Pub. No.: US 2022/0132289 A1
(43) Pub. Date: Apr. 28, 2022

(54) SYSTEM AND METHOD FOR TRANSMISSION OF AN EMERGENCY MESSAGE FROM A HOST VEHICLE VIA A VEHICLE-TO-X COMMUNICATION SYSTEM

(71) Applicant: Lear Corporation, Southfield, MI (US)

(72) Inventors: Jagat GHIMIRE, Southfield, MI (US); Hongen TU, Southfield, MI (US); Christian BALMACEDA, Southfield, MI (US); David R. MULLIGAN, Livonia, MI (US)

(73) Assignee: Lear Corporation, Southfield, MI (US)

(21) Appl. No.: 17/081,108

(22) Filed: Oct. 27, 2020

(51) Int. Cl. H04W 4/90; H04W 4/40; H04W 4/02

(52) U.S. Cl. CPC H04W 4/90; H04W 4/025; H04W 4/40

(57) ABSTRACT

A system and method are described for transmission of an emergency message from a host vehicle. The system includes a communication unit to be mounted in the host vehicle and configured to transmit a vehicle-to-x communication including data indicative of the host vehicle. The system also includes controller to be mounted in the host vehicle and provided in communication with the communication unit. In response to an indication of an accident involving the host vehicle and an indication that a cellular communication unit mounted in the host vehicle is inoperative, the controller is configured to generate an emergency message for transmission by the communication unit.

### TECHNICAL FIELD

The following relates to a system and method for transmission of an emergency message from a host vehicle via a vehicle-to-x (V2X) communication system.

### BACKGROUND

Vehicle-to-everything (V2X) communication is the passing of information from a vehicle to any entity that may affect the vehicle, and vice versa. V2X is a vehicular communication system that incorporates or includes other more specific types of communication such as Vehicle-to-Infrastructure (V2I), Vehicle-to-Network (V2N), Vehicle-to-Vehicle (V2V), Vehicle-to-Pedestrian (V2P), Vehicle-to-Device (V2D), and Vehicle-to-Grid (V2G). The main motivations for V2X communication are road safety, traffic efficiency, and energy savings.

There are two types of V2X communication technology depending on the underlying technology being used. One is Dedicated Short Range Communication (DSRC) Wireless Local Area Network (WLAN) based, and the other is cellular based (which may be referred to as CV2X). V2X communication may use WLAN technology and work directly between vehicles, which form a vehicular ad-hoc network as two V2X transmitters come within each range of each other. Hence it does not require any infrastructure for vehicles to communicate, which is key to assure safety in remote or little developed areas.

WLAN is particularly well-suited for V2X communication, due to its low latency. It transmits and receives messages known as Cooperative Awareness Messages (CAM) and Decentralized Environmental Notification Messages (DENM) or Basic Safety Message (BSM) at regular intervals (e.g., up to 10 times per second). The data volume of these messages is very low. The radio technology is part of the WLAN 802.11 family of standards developed by the Institute of Electrical and Electronics Engineers (IEEE) and known in the United States as Wireless Access in Vehicular Environments (WAVE) and in Europe as ITS-G5.

A European Union (EU) initiative known as eCall is intended to bring rapid assistance to motorists involved in a collision anywhere in the EU and was made mandatory in all new cars sold within the EU from April 2018. The eCall initiative utilizes a system that automatically contacts emergency services in the event of a serious accident, sending vehicle location and sensor information. The eCall initiative and/or similar systems utilize a device, such as for example a Telematics Control Unit (TCU), installed in a host vehicles that will automatically dial authorities (e.g., an emergency number) in the event of a serious road accident involving the host vehicle, and send information such as airbag deployment information, impact sensor information, and GNSS coordinates to local emergency agencies over a cellular network. (See, e.g., https://en.wikipedia.org/wiki/ECall.)

However, eCall or any similar initiatives in other regions or countries relies on the availability of cellular network connectivity. There are situations where cellular coverage or services are not available at the location of an accident. Moreover, cellular availability is also heavily reliant on the service provider that a vehicle Original Equipment Manufacturer (OEM) chooses to install on its vehicles. For example, ATT and T-Mobile have different coverage maps.

Furthermore, eCall and similar messages are only intended for emergency services and can only be sent to authorities. As a result, other drivers on the road in close proximity may not be aware of an emergency situation that gave rise to the transmission of an eCall or similar message or have access to information concerning such an emergency situation. Drivers passing by could therefore potentially miss the accident and be unable to provide much needed help. As well, no backup communication mechanism is available in the event that the module, antenna, and/or software of such a host vehicle eCall or similar device or system is damaged or corrupted and unable to send any messages over a cellular network.

A need therefore exists for an improved system and method for transmission of an emergency message from a host vehicle via a V2X communication system. Such an improved system and method would utilize V2X communications to help address, reduce, mitigate, solve, or eliminate the issues or problems described above associated with eCall or similar systems.

### SUMMARY

According to one non-limiting exemplary embodiment described herein, a system is provided for transmission of an emergency message from a host vehicle. The system may comprise a communication unit to be mounted in the host vehicle and configured to transmit a vehicle-to-x communication comprising data indicative of the host vehicle, and a controller to be mounted in the host vehicle and provided in communication with the communication unit. In response to an indication of an accident involving the host vehicle and an indication that a cellular communication unit mounted in the host vehicle is inoperative, the controller is configured to generate an emergency message for transmission by the communication unit.

According to another non-limiting exemplary embodiment described herein, a method is provided for transmission of an emergency message from a host vehicle including a vehicle-to-x communication system. The method comprises generating at the host vehicle an indication of an accident involving the host vehicle. The method further comprises generating at the host vehicle an emergency message for transmission in a vehicle-to-x communication in response to the indication of an accident involving the host vehicle and an indication that a cellular communication unit mounted in the host vehicle is inoperative.

A detailed description of these and other non-limiting exemplary embodiments of a system and method for transmission of an emergency message from a host vehicle via a vehicle-to-x (V2X) communication system is set forth below together with the accompanying drawings.

### BRIEF DESCRIPTION OF THE DRAWINGS

FIG. 1 is a block diagram of non-limiting exemplary vehicles equipped with a non-limiting exemplary V2X communication system for use with the system and method for transmission of an emergency message from a host vehicle via a V2X communication system according to one non-limiting exemplary embodiment of the present disclosure;

FIG. 2A is a diagram of a non-limiting exemplary event which may be associated with a system and method for transmission of an emergency message from a host vehicle via a V2X communication system according to one non-limiting exemplary embodiment of the present disclosure;

FIG. 2B is a block diagram of a non-limiting exemplary embodiment of an emergency message for use with the non-limiting exemplary event of FIG. 2A;

FIG. 3A is a diagram of another non-limiting exemplary event which may be associated with a system and method for transmission of an emergency message from a host vehicle via a V2X communication system according to one non-limiting exemplary embodiment of the present disclosure;

FIG. 3B is a block diagram of a non-limiting exemplary embodiment of an emergency message for use with the non-limiting exemplary event of FIG. 3A;

FIG. 4A is a diagram of another non-limiting exemplary event which may be associated with a system and method for transmission of an emergency message from a host vehicle via a V2X communication system according to one non-limiting exemplary embodiment of the present disclosure;

FIG. 4B is a block diagram of a non-limiting exemplary embodiment of an emergency message for use with the non-limiting exemplary event of FIG. 4A; and

FIG. 4C is a block diagram of another non-limiting exemplary embodiment of an emergency message for use with the non-limiting exemplary event of FIG. 4A.

### DETAILED DESCRIPTION

As required, detailed non-limiting embodiments are disclosed herein. However, it is to be understood that the disclosed embodiments are merely exemplary and may take various and alternative forms. The figures are not necessarily to scale, and features may be exaggerated or minimized to show details of particular components. Therefore, specific structural and functional details disclosed herein are not to be interpreted as limiting, but merely as a representative basis for teaching one skilled in the art.

With reference to the Figures, a more detailed description of non-limiting exemplary embodiments of system and method for transmission of an emergency message from a host vehicle via a vehicle-to-x (V2X) communication system will be provided. For ease of illustration and to facilitate understanding, like reference numerals may be used herein for like components and features throughout the drawings.

As previously described, vehicle-to-everything (V2X) communication is the passing of information from a vehicle to any entity that may affect the vehicle, and vice versa. V2X is a vehicular communication system that incorporates or includes other more specific types of communication such as Vehicle-to-Infrastructure (V2I), Vehicle-to-Network (V2N), Vehicle-to-Vehicle (V2V), Vehicle-to-Pedestrian (V2P), Vehicle-to-Device (V2D), and Vehicle-to-Grid (V2G). V2X/CV2X communication is designed to improve road safety, traffic efficiency, and energy savings, and may be implemented using Dedicated Short Range Communication (DSRC) Wireless Local Area Network (WLAN) technology, or alternatively cellular technology. V2X communication may use WLAN technology and work directly between vehicles, which form a vehicular ad-hoc network as two V2X transmitters come within each range of each other. Hence it does not require any infrastructure for vehicles to communicate, which is key to assure safety in remote or little developed areas. WLAN is particularly well-suited for V2X communication, due to its low latency. It transmits messages known as Cooperative Awareness Messages (CAM) and Decentralized Environmental Notification Messages (DENM) or Basic Safety Message (BSM). The data volume of these messages is very low. The radio technology is part of the WLAN 802.11 family of standards developed by the Institute of Electrical and Electronics Engineers (IEEE) and known in the United States as Wireless Access in Vehicular Environments (WAVE) and in Europe as ITS-G5.

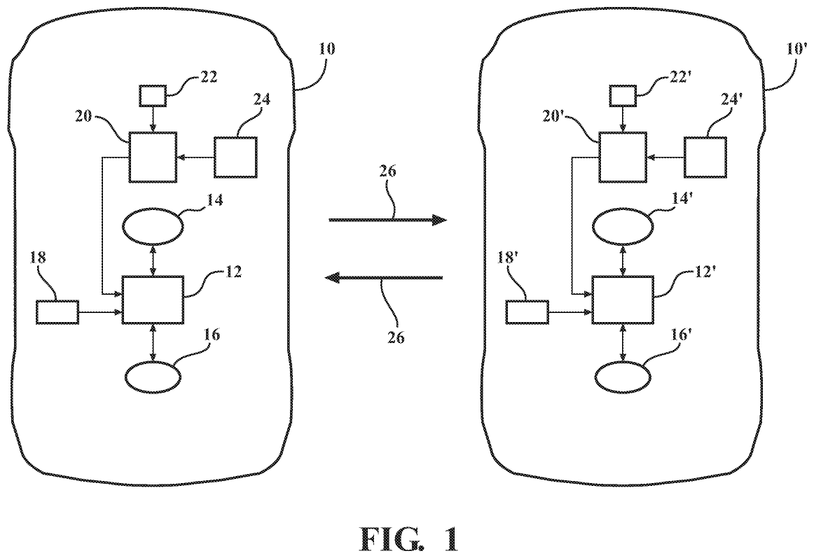

Referring now to FIG. 1, a block diagram of non-limiting exemplary vehicles equipped with a non-limiting exemplary V2X communication system for use with the system and method for transmission of an emergency message from a host vehicle via a V2X communication system according to one non-limiting exemplary embodiment of the present disclosure is shown. As seen therein, a first vehicle 10 may comprise a V2X module 12, a first antenna 14, a second antenna 16, a Global Positioning System (GPS) or other GNSS unit 18, a controller 20, a sensor 22, and a cellular communication unit 24. In that regard, the cellular communication unit 24 may comprise a Telematics Control Unit (TCU) as previously described or a similarly configured unit for enabling and/or controlling the generation and/or transmission of emergency cellular communications or messages in the event of an accident involving the first vehicle 10, such as previously described in connection with the eCall initiative. The V2X module 12, or the V2X module 12 and the first and second antennas 14, 16 together, may be referred to or comprise a vehicle On-Board Unit (OBU). The controller 20 may be provided in communication with the sensor 22, the cellular communication unit 24, and the V2X module 12, which itself may be provided in communication with the first and second antennas 14, 16 and the GPS 18.

The controller 20 may be configured to receive from the sensor 22 an indication of an accident involving the host vehicle 10. In that regard, the sensor 22 may be of any known type and may be configured to sense any parameter suitable to detect or indicate a collision or accident involving the first vehicle 10 (e.g., an impact sensor or an accelerometer). While a single sensor 22 is shown in FIG. 1, any number of sensors may be utilized for such purposes and may form a sensor network in the first vehicle 10. As well, the sensor 22 may be part of any known driver assistance system (not shown), such as a collision warning system or accident detection system. It should be noted, however, that any known alternative means or methods may be employed to generate or provide an indication of an accident involving the first vehicle 10.

The controller 20 may be further configured to receive from the cellular communication unit 24 an indication that the cellular communication unit 24 is inoperative, i.e., unable to transmit cellular communication signals. Such an indication may take the form of an absence of a signal from cellular communication unit 24, which absence may indicate an inability of the cellular communication unit 24 to transmit cellular communication signals as a result of damage to the unit 24, which may result from an accident involving the host vehicle 10. Such an indication may additionally or alternatively take the form of a signal from the cellular communication unit 24 indicating an absence of cellular network coverage at a current location of the host vehicle 10 and thus an inability of the cellular communication unit 24 to transmit cellular communication signals. It should be noted, however, that any known alternative means or methods may be employed to generate or provide an indication that the cellular communication unit 24 is inoperative. In response to an indication of an accident involving the host vehicle 10 and an indication that the cellular communication unit 24 is inoperative, the controller 20 may be further configured to generate an emergency message for transmission by the V2X communication unit 12 as described herein.

It should be noted that, while shown in FIG. 1 as separate components, the V2X module 12 and the controller 20 may be integrated into a single unit or module, such as the V2X module 12 itself. In that same regard, while the GPS 18 is shown as provided in communication with the V2X module 12, the GPS 18 may additionally or alternatively be provided in communication with the controller 20 and/or a unit or module in which the V2X module 12 and controller 20 are integrated, as previously described.

Still referring to FIG. 1, a second vehicle 10′ may similarly comprise a V2X module 12′, a first antenna 14′, a second antenna 16′, a GPS or other GNSS unit 18′, a controller 20′, a sensor 22′, and a cellular communication unit 24′. The V2X module 12′, first and second antennas 14′, 16′, GPS 18′, controller 20′, sensor 22′, and cellular communication unit 24′ of the second vehicle 10′ may be provided in communication and configured similarly to the V2X module 12, the first and second antennas 14, 16, the GPS 18, the controller 20, the sensor 22, and the cellular communication unit 24 of the first vehicle 10 as described above.

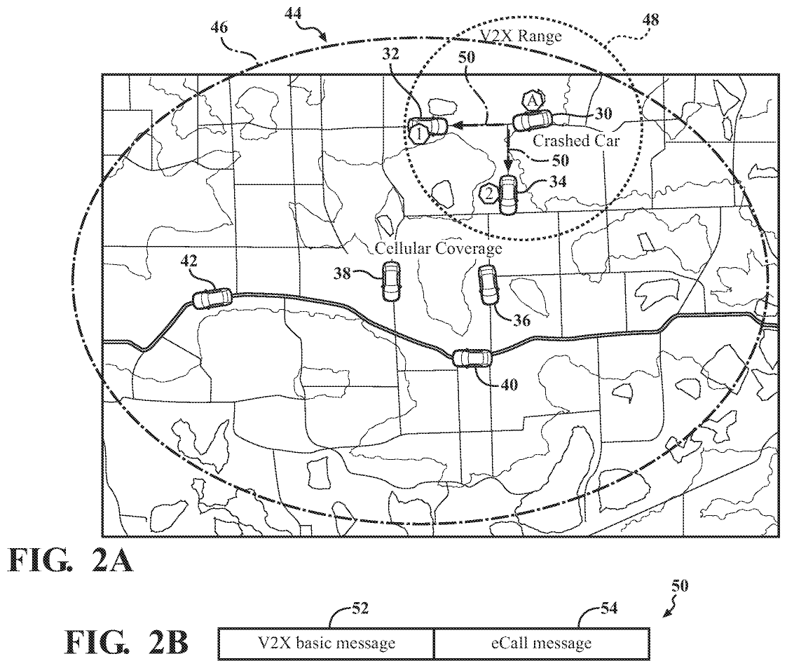

It should be noted that either of the first or second vehicles 10, 10′ may be referred to as a host vehicle. It should also be noted that the description herein of the system and method of the present disclosure in connection with the first and second vehicles 10, 10′ is exemplary only, and that the system and method of the present disclosure may be utilized or implemented with any number of vehicles, such as shown in FIGS. 2A, 3A, and 4A.

Each of the V2X modules 12, 12′ may be configured to enable and control communication between the first and second vehicles 10, 10′ (i.e., V2V communication) or between the first or second vehicle 10, 10′ and another node or device (e.g., Vehicle-to-Infrastructure (V2I), Vehicle-to-Network (V2N), Vehicle-to-Pedestrian (V2P), Vehicle-to-Device (V2D), or Vehicle-to-Grid (V2G)). Such communication is accomplished utilizing radio frequency signals for transmission of data according to known techniques, protocols, and/or standards associated with such communication. In that regard, the first and/or second antennas 14, 14′, 16, 16′ of the first and second vehicles 10, 10′ may be configured for transmitting and receiving DSRC WLAN or cellular radio frequency signals. Similarly, the GPS or other GNSS units 18, 18′ of the first and second vehicles 10, 10′ may be configured and operate in any known fashion, including providing for wireless GNSS communication.

Each V2X module 12, 12′ and/or each V2X module 12, 12′ with antennas 14, 14′, 16, 16′ may also be referred to as a communication unit that may be configured to transmit and receive wireless V2X radio frequency communications 26 as described herein. Similarly, each controller 20, 20′ may include a communication interface or communication unit that may be configured to transmit and/or receive wired communication signals to and/or from its respective V2X module 12, 12′, sensors 22, 22′, and cellular communication units 24, 24′ over any vehicle bus, such as a Controller Area Network (CAN) bus.

As those skilled in the art will understand, the V2X modules 12, 12′, antennas 14, 14′, 16, 16′, GPS 18, 18′, controllers 20, 20′, sensors 22, 22′, and/or cellular communication unit 24, 24′ of the first and second vehicles 10, 10′, as well as any other module, controller, unit, component, system, subsystem, interface, sensor, component, device, or the like described herein may individually, collectively, or in any combination comprise appropriate circuitry, such as one or more appropriately programmed processors (e.g., one or more microprocessors including central processing units (CPU)) and associated memory, which may include stored operating system software, firmware, and/or application software executable by the processor(s) for controlling operation thereof and for performing the particular algorithm or algorithms represented by the various functions and/or operations described herein, including interaction between and/or cooperation with each other. One or more of such processors, as well as other circuitry and/or hardware, may be included in a single Application-Specific Integrated Circuitry (ASIC), or several processors and various circuitry and/or hardware may be distributed among several separate components, whether individually packaged or assembled into a System-on-a-Chip (SoC). The V2X/CV2X modules 12, 12′, antennas 14, 14′, 16, 16′, GPS 18, 18′, controllers 20, 20′, sensors 22, 22′, and/or cellular communication units 24, 24′ may therefore each or in any combination comprise a processor and an associated storage medium having stored computer executable instructions for performing the particular algorithm or algorithms represented by the various functions and/or operations described herein.

As previously noted, all V2X communications 26 include a Basic Safety Message (BSM). As part of each BSM, a DSRC device, such as V2X module 12, 12′ must transmit (i) Longitudinal and latitudinal location within 1.5 meters of the actual position at a Horizontal Dilution of Precision (HDOP) smaller than 5 within the 1 sigma absolute error; and (ii) Elevation location within 3 meters of the actual position at a Horizontal Dilution of Precision (HDOP) smaller than 5 within the 1 sigma absolute error. As part of each BSM, a DSRC device must also transmit speed, heading, acceleration, and yaw rate. Speed must be reported in increments of 0.02 m/s, within 1 km/h (0.28 m/s) of actual vehicle speed. Heading must be reported accurately to within 2 degrees when the vehicle speed is greater than 12.5 m/s (˜28 mph), and to within 3 degrees when the vehicle speed is less than or equal to 12.5 m/s. Additionally, when the vehicle speed is below 1.11 m/s (˜2.5 mph), the DSRC device must latch the current heading and transmit the last heading information prior to the speed dropping below 1.11 m/s. The DSRC device is to unlatch the latched heading when the vehicle speed exceeds 1.39 m/s (˜3.1 mph) and transmit a heading within 3 degrees of its actual heading until the vehicle reaches a speed of 12.5 m/s where the heading must be transmitted at 2 degrees accuracy of its actual heading. Horizontal (longitudinal and latitudinal) acceleration must be reported accurately to 0.3 m/s², and vertical acceleration must be reported accurately to 1 m/s². Yaw rate must be reported accurately to 0.5 degrees/second.

In addition, a Path History data frame will be transmitted as a required BSM element at the operational frequency of the BSM transmission. The Path History data frame requires a history of past vehicles Global Navigation Satellite System (GNSS) locations as dictated by GNSS data elements including Coordinated Universal Time (UTC) time, latitude, longitude, heading, elevation sampled at a periodic time interval of 100 ms and interpolated in-between by circular arcs, to represent the recent movement of the vehicle over a limited period of time or distance. Path History points should be incorporated into the Path History data frame such that the perpendicular distance between any point on the vehicle path and the line connecting two consecutive PH points shall be less than 1 m. The number of Path History points that a vehicle should report is the minimum number of points so that the represented Path History distance (i.e., the distance between the first and last Path History point) is at least 300 m and no more than 310 m, unless initially there is less than 300 m of Path History. If the number of Path History points needed to meet both the error and distance requirements stated above exceeds the maximum allowable number of points (23), the Path History data frame shall be populated with only the 23 most recent points from the computed set of points. A Path History data frame shall be populated with time-ordered Path History points, with the first Path History point being the closest in time to the current UTC time, and older points following in the order in which they were determined.

Path Prediction trajectories will also be transmitted as a required BSM element at the operational frequency of the BSM transmission. Trajectories in a Path Prediction data frame are represented, at a first order of curvature approximation, as a circle with a radius, R, and an origin located at (0,R), where the x-axis is aligned with the perspective of the transmitting vehicle and normal to the vertical axis of the vehicle. The radius, R, will be positive for curvatures to the right when observed from the perspective of the transmitting vehicle, and radii exceeding a maximum value of 32,767 are to be interpreted as a “straight path” prediction by receiving vehicles. When a DSRC device is in steady state conditions over a range from 100 m to 2,500 m in magnitude, the subsystem will populate the Path Prediction data frame with a calculated radius that has less than 2% error from the actual radius. For the purposes of this performance requirement, steady state conditions are defined as those which occur when the vehicle is driving on a curve with a constant radius and where the average of the absolute value of the change of yaw rate over time is smaller than 0.5 deg/s². After a transition from the original constant radius (R1) to the target constant radius (R2), the subsystem shall repopulate the Path Prediction data frame within four seconds under the maximum allowable error bound defined above.

The foregoing and other details concerning V2X communications relating to Federal Motor Vehicle Safety Standards are set forth at 49 CFR (Code of Federal Regulations) Part 571 as well as the Notice of Proposed Rulemaking (NPRM), National Highway Transportation Safety Association Docket No. NHTSA-201600126, which are incorporated herein by reference in their entireties. Also incorporated herein by reference in its entirety is the DSRC standard of the Society of Automotive Engineers, SAE J2945, relating to on-board system requirements for V2V safety communications, including FIGS. 27 and 30 concerning concise and actual path history representation and representation of estimated radius calculations.

As previously described, the EU eCall initiative and/or similar systems utilize a device (e.g., TCU) installed in a host vehicle that automatically dials authorities (e.g., an emergency number) in the event of a serious road accident, and sends airbag deployment information, impact sensor information, and GNSS coordinates to local emergency agencies over a cellular network. However, such systems rely on the availability of cellular network connectivity, which may not necessarily be available at an accident location, such as due to the accident or an absence of cellular network coverage. Moreover, eCall and similar messages are only intended for emergency services and can only be sent to authorities. As a result, other drivers on the road in close proximity may not be aware of an emergency situation that gave rise to the transmission of an eCall or similar message or have access to information concerning such an emergency situation and thus may miss the accident or be unable to provide assistance. Furthermore, no backup communication mechanism is available in the event that the module, antenna, and/or software of such a device is damaged, corrupted, or otherwise inoperative and unable to send any messages over a cellular network.

The present disclosure provides an improved system and method for transmission of an emergency message from a host vehicle via a V2X communication system to help address, reduce, mitigate, solve, or eliminate such issues or problems. In that regard, the system and method of the present disclosure may incorporate an eCall or similar message or information and send such information via V2X radio to surrounding vehicles. In such a fashion, the driver or end user of another vehicle equipped with a V2X receiver and within V2X radio range may be notified with an eCall message. In that regard, an eCall can add more detailed information compared to the standard BSM used in V2X communication systems.

The system and method of the present disclosure may also propagate an eCall message or information via a V2X network to an area where cellular coverage is available in order to enable or allow for notification of emergency services by another vehicle via an eCall or similar system or device. In that regard, the system and method of the present disclosure may employ or utilize a mechanism to prevent excessive propagation of an eCall message or information through daisy-chaining (e.g., geographic limits, propagation counter, or a positive response from emergency services) to promptly terminate propagation.

The system and method of the present disclosure may also activate an eCall or similar application and/or continue a V2X application after an accident involving a host vehicle occurs. In that regard, the system and method of the present disclosure may include or utilize a power management scheme or device to ensure, enable, or provide that a host vehicle V2X radio continues to operate if, for example, the engine of the host vehicle stalls after an accident, such as by providing for the continued and/or uninterrupted delivery of electrical power by the host vehicle battery or a backup battery.

Referring now to FIG. 2A, a diagram is shown of a non-limiting exemplary event which may be associated with a system and method for transmission of an emergency message from a host vehicle via a V2X communication system according to one non-limiting exemplary embodiment of the present disclosure. In that regard, FIG. 2B is a block diagram of a non-limiting exemplary embodiment of an emergency message for use with the non-limiting exemplary event of FIG. 2A.

As seen therein, a number of vehicles 30, 32, 34, 36, 38, 40, 42 may be located in a geographic area 44 having a cellular network coverage area 46 provided by a commercial cellular network service provider. Each of the vehicles 30, 32, 34, 36, 38, 40, 42 may be a vehicle of the type described in connection with FIG. 1 (e.g., vehicle 10). That is, each of the vehicles 30, 32, 34, 36, 38, 40, 42 may be equipped with, include or comprise a V2X communication unit (e.g., V2X module 12 and antennas 14, 16), as well as an eCall or similar system (e.g., including cellular communication unit 24) and may be referred to as a host vehicle.

Still referring to FIG. 2A, and with continuing reference to FIG. 1, the vehicle 30 (A) may be involved in an accident, collision, or crash and, as a result, the cellular communication unit 24 of the vehicle 30 (A) may be inoperative due to damage. In that event, an eCall or similar message, including the information included in such a message such as airbag deployment information, impact sensor information, and GNSS coordinates relating to the vehicle 30 (A), that would have been transmitted by the cellular communication unit 24 of the vehicle 30 (A) can instead be included as part of a V2X message 50 and broadcast from the vehicle 30 (A) to all other vehicles, such as the vehicles 32, 34, within range or the coverage area 48 of the V2X communication unit 12 of the vehicle 30 (A).

As seen in FIG. 2B, such a V2X communication 50 may comprise a V2X BSM 52 having an eCall or similar message 54 attached thereto. Such a V2X message 50 having a BSM 52 and eCall or similar message 54 packaged together may be sent out via the V2X communication unit 12 of the vehicle 30 (A) so that vehicles, such as the vehicles 32, 34 in close proximity to the vehicle 30 (A) receive the V2X communication 50. As illustrated in the example shown in FIG. 2A, only the vehicles 32, 34 are within such a range 48 of the V2X communication unit 12 of the vehicle 30 (A) and therefore receive the V2X message 50 from the vehicle 30 (A). Due to the nature of the transmission distance of V2X messages, a vehicle or vehicles at a further distance or distances away from the vehicle 30 (A) outside the range 48 of the V2X communication unit 12 of the vehicle 30 (A), such as vehicles 36, 38, 40, 42, do not get flooded with information since those vehicles 36, 38, 40, 42 are all out of context for the accident or incident.

The vehicles 32, 34, which have operational cellular communication units 24, may then automatically dial authorities (e.g., an emergency number) and sends eCall information such as airbag deployment information, impact sensor information, and GNSS coordinates relating to the vehicle 30 (A) (which information was included in the V2X message 50) to local emergency agencies over a cellular network in a fashion as previously described in connection with eCall or a similar system. Moreover, the controller 20 of each of the vehicle 32, 34 may also be configured to generate, provide, or effectuate a driver alert notification in response to receipt of the V2X communication 50 with the eCall message 54 and its information via the V2X communication unit 12 of that vehicle 32, 34. Such a driver alert notification may be an audio message, warning light, or other alert provide to the driver in any known fashion. In this way, the drivers of such vehicles 32, 34 may be notified of the accident involving the vehicle 30 (A) and have the option to render aid if needed.

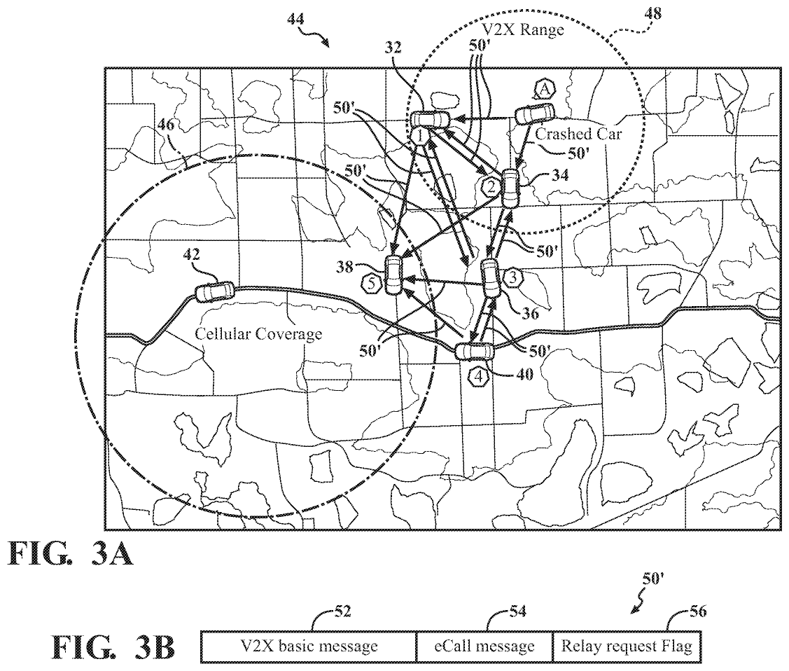

Referring now to FIG. 3A, a diagram is shown of another non-limiting exemplary event which may be associated with a system and method for transmission of an emergency message from a host vehicle via a V2X communication system according to one non-limiting exemplary embodiment of the present disclosure. In that regard, FIG. 3B is a block diagram of a non-limiting exemplary embodiment of an emergency message for use with the non-limiting exemplary event of FIG. 3A.

As seen therein, vehicles 38, 42 may be located in a portion of a geographic area 44 having a cellular network coverage area 46 provided by a cellular network service provider. Vehicles 30, 32, 34, 36, 40 may be located in another portion of the geographic area 44 outside the cellular coverage area 46. Once again, each of the vehicles 30, 32, 34, 36, 38, 40, 42 may be a vehicle of the type described in connection with FIG. 1 (e.g., vehicle 10). That is, each of the vehicles 30, 32, 34, 36, 38, 40, 42 may be equipped with, include or comprise a V2X communication unit (e.g., V2X module 12 and antennas 14, 16), as well as an eCall or similar system (e.g., including cellular communication unit 24).

Still referring to FIG. 3A, and with continuing reference to FIG. 1, the vehicle 30 (A) may be involved in an accident, collision, or crash. However, because vehicle 30 (A) is located outside the cellular coverage area 46, the cellular communication unit 24 of the vehicle 30 (A) is unable to transmit eCall or similar cellular communications signals or messages over the cellular network system. In that event, an eCall or similar message, including the information included in such a message such as airbag deployment information, impact sensor information, and GNSS coordinates relating to the vehicle 30 (A), that would have been transmitted by the cellular communication unit 24 of the vehicle 30 (A) can instead be included as part of a V2X message 50′ and broadcast from the vehicle 30 (A) to all other vehicles, such as the vehicles 32, 34, within range or the coverage area 48 of the V2X communication unit 12 of the vehicle 30 (A).

As seen in FIG. 3B, such a V2X communication 50′ may again comprise a V2X BSM 52 having an eCall or similar message 54 attached thereto. Such a V2X message 50′ having a BSM 52 and eCall or similar message 54 packaged together may be sent out via the V2X communication unit 12 of the vehicle 30 (A) so that vehicles in close proximity to the vehicle 30 (A), such as the vehicles 32, 34, receive the V2X communication 50′.

As also seen in FIG. 3B, the V2X communication 50′ may further comprise a relay request flag 56. In that regard, if the vehicle 30 (A) is unable to transmit an eCall or similar cellular message or has failed to reach out to emergency services, a relay request flag 56 may be attached to or embedded in a V2X BSM 52 which can be used as indication that relay transmission of the V2X communication 50′ over V2X radio is required. Once such a relay request flag 56 is set, whenever a vehicle (e.g., vehicles 32, 34) receive the V2X communication 50′ with eCall message 54 information via V2X radio, that vehicle will automatically relay the V2X communication 50′ to all surrounding vehicles if that vehicle itself is unable to transmit an eCall or similar message via the cellular network in order to notify emergency services.

As a result, a vehicle or vehicles within V2X range (e.g., vehicles 32, 34) will not only receive the eCall information via V2X radio but also propagate the V2X communication 50′ to surrounding vehicles (e.g., vehicles 36, 38, 40) until a vehicle located within the cellular coverage area 46 (e.g., vehicle 38) receives the V2X message 50′ and is therefore able to send an eCall or similar cellular message over the cellular network. In that event, the relay request flag 56 may be cleared in order to stop propagation of the V2X communication 50′.

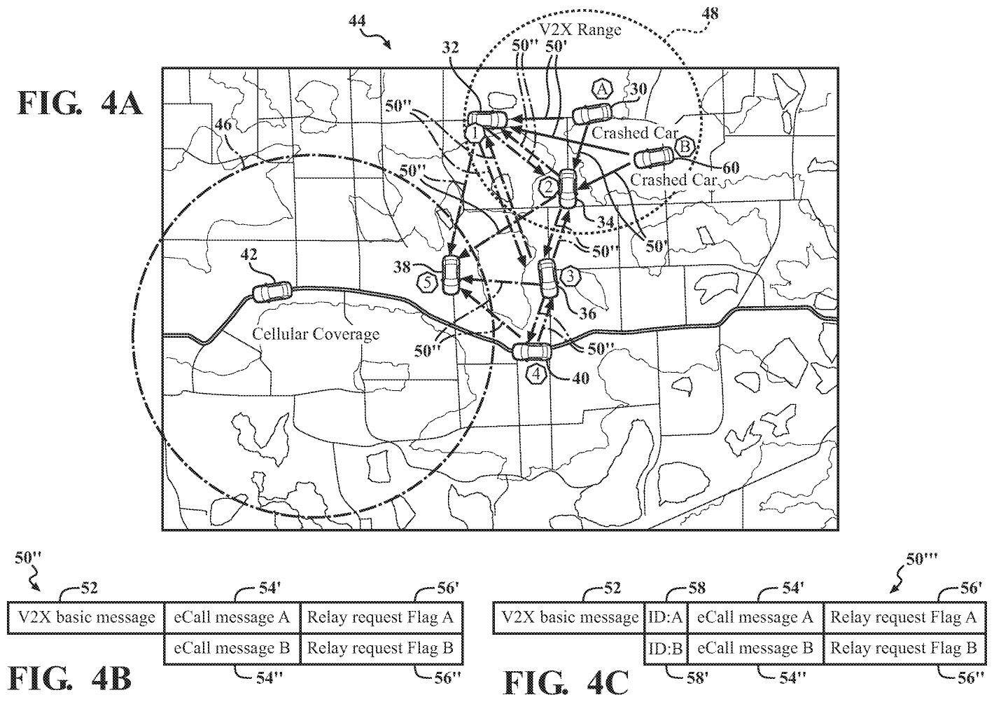

Referring now to FIG. 4A, a diagram is shown of another non-limiting exemplary event which may be associated with a system and method for transmission of an emergency message from a host vehicle via a V2X communication system according to one non-limiting exemplary embodiment of the present disclosure. In that regard, FIGS. 4B and 4C are block diagrams of non-limiting exemplary embodiments of emergency messages for use with the non-limiting exemplary event of FIG. 4A.

As seen in FIG. 4A, vehicles 38, 42 may be located in a portion of a geographic area 44 having a cellular network coverage area 46 provided by a cellular network service provider. Vehicles 30, 32, 34, 36, 40, 60 may be located in another portion of the geographic area 44 outside the cellular coverage area 46. Once again, each of the vehicles 30, 32, 34, 36, 38, 40, 42, 60 may be a vehicle of the type described in connection with FIG. 1 (e.g., vehicle 10). That is, each of the vehicles 30, 32, 34, 36, 38, 40, 42, 60 may be equipped with, include or comprise a V2X communication unit (e.g., V2X module 12 and antennas 14, 16), as well as an eCall or similar system (e.g., including cellular communication unit 24).

FIG. 4A thus illustrates an event similar to that shown in FIG. 3A. However, in FIG. 4A, both the vehicle 30 (A) and the vehicle 60 (B) may be involved in an accident, collision, or crash. Indeed, accidents commonly involve multiple vehicles at close proximity. Because both vehicle 30 (A) and vehicle 60 (B) are located outside the cellular coverage area 46, each of the cellular communication units 24 of the vehicles 30 (A) and 60 (B) are unable to transmit eCall or similar cellular communications signals or messages over the cellular network system. In that event, an eCall or similar message, including the information included in such a message such as airbag deployment information, impact sensor information, and GNSS coordinates relating to the vehicle 30 (A), that would have been transmitted by the cellular communication unit 24 of the vehicle 30 (A) can instead be included as part of a V2X communication 50′ (see FIG. 3B) and broadcast from the vehicle 30 (A) to all other vehicles, such as the vehicles 32, 34, within range or the coverage area 48 of the V2X communication unit 12 of the vehicles 30 (A). Similarly, an eCall or similar message, including the information included in such a message such as airbag deployment information, impact sensor information, and GNSS coordinates relating to the vehicle 60 (B), that would have been transmitted by the cellular communication unit 24 of the vehicle 60 (B) can instead be included as part of a V2X communication 50′ (see FIG. 3B) and broadcast from the vehicle 60 (B) to all other vehicles, such as the vehicles 32, 34, within range or the coverage area 48 of the V2X communication unit 12 of the vehicles 60 (B).

In such an event, eCall message information from multiple incident vehicles can be appended to V2X messages. As seen in FIG. 4B, such a V2X communication 50″ may again comprise a V2X BSM 52 having an eCall or similar message A 54′ and an eCall or similar message B 54″ attached thereto, which messages 54′ and 54″ are associated with vehicles 30 (A) and 60 (B), respectively. Such a V2X message 50″ having a BSM 52 and eCall or similar messages 54′, 54″ packaged together may be sent out via the V2X communication units 12 of the vehicles 32, 34 so that vehicles in close proximity to the vehicles 32, 34, such as the vehicles 36, 38, 40, receive the V2X communication 50″.

As also seen in FIG. 4B, the V2X communication 50″ may further comprise relay request flag A 56′ and relay request flag B 56″. In that regard, as previously described, if the vehicle 30 (A) is unable to transmit an eCall or similar cellular message or has failed to reach out to emergency services, a relay request flag 56 may be attached to or embedded in a V2X BSM 52 which can be used as indication that relay transmission of the V2X communication 50′ (see FIG. 3B) over V2X radio is required. Similarly, if the vehicle 60 (B) is unable to transmit an eCall or similar cellular message or has failed to reach out to emergency services, a relay request flag 56 may be attached to or embedded in a V2X BSM 52 (see FIG. 3B) which can be used as indication that relay transmission of the V2X communication 50′ over V2X radio is required. Once such a relay request flag 56 is set, whenever a vehicle (e.g., vehicles 32, 34) receive the V2X communication 50′ with eCall message 54 information via V2X radio, that vehicle will automatically relay the V2X communication 50″ to all surrounding vehicles (e.g., vehicles 36, 38, 40) if that vehicle itself is unable to transmit an eCall or similar message via the cellular network in order to notify emergency services. Once again, the V2X communication 50″ may comprise relay request flags A 56′ and B 56″ attached thereto, which relay request flags 56′ and 56″ are associated with vehicles 30 (A) and 60 (B), respectively. In such a fashion, both vehicles 30 (A) and 60 (B) can get their eCall message information 54′, 54″ relayed at the same time.

As a result, a vehicle or vehicles within V2X range (e.g., vehicles 32, 34) will not only receive the eCall information via V2X radio but once again also propagate the V2X communication 50″ to surrounding vehicles (e.g., vehicles 36, 38, 40) until a vehicle located within the cellular coverage area 46 (e.g., vehicle 38) receives the V2X message 50″ and is therefore able to send an eCall or similar cellular message over the cellular network. In that event, the relay request flags 56′, 56″ may be cleared in order to stop propagation of the V2X communication 50″.

The vehicles (e.g., vehicles 32, 34, 36, 40) relaying and/or propagating the V2X communication 50″ of FIG. 4B may alternatively relay and/or propagate a modified V2X communication 50′″ shown in FIG. 4C, which may further comprise a unique incident identification (ID). More specifically, the V2X communication 50′″ may again comprise a V2X BSM 52 having an eCall or similar message A 54′ and an eCall or similar message B 54″ attached thereto, which messages 54′ and 54″ are associated with vehicles 30 (A) and 60 (B), respectively. As well, the V2X communication 50′″ may again comprise relay request flags A 56′ and B 56″ attached thereto, which relay request flags 56′ and 56″ are associated with vehicles 30 (A) and 60 (B), respectively. The V2X communication 50′″ may further comprise an incident ID A 58 associated with the vehicle 30 (A) and an incident ID B 58′ associated with the vehicle 60 (B). By implementing a unique incident ID to identify an accident, such as incident ID A 58 and incident ID B 58′, the system and method of the present application may prevent runaway propagation which causes repropagation of the same incident. The Incident ID can be generated, for example, based on the timestamp of the incident, GPS coordinates, Vehicle Identification Number (VIN), and other unique numbers (e.g., a generated pseudorandom number), which guarantees each incident will have a unique Incident ID.

In addition, to prevent V2X communications 50, 50′, 50″, 50′″ to be propagated to all other vehicles, which may bring no added value to the incident and which may cause unnecessary V2X network traffic, a geo-fencing algorithm may be implemented. In such a fashion, V2X communications 50, 50′, 50″, 50′″ will only be relayed over a local geographic area, which area may be selected or defined as desired in any known fashion. For example, geofencing may be based on map data indicating close proximity to fire or police stations.

Referring now to FIGS. 1-4C, the present disclosure describes a system and method for transmission of an emergency message from a host vehicle via a V2X communication system. The system may comprise a communication unit 12 to be mounted in the host vehicle 10, 30, 32, 34, 36, 38, 40, 42, 60 and configured to transmit a V2X communications 26 comprising data indicative of the host vehicle 10, 30, 32, 34, 36, 38, 40, 42, 60. The system may further comprise a controller 20 to be mounted in the host vehicle 10, 30, 32, 34, 36, 38, 40, 42, 60 and provided in communication with the communication unit 12 thereof. In response to an indication of an accident involving the host vehicle, e.g., vehicle 30, 60, and an indication that a cellular communication unit 24 mounted in the host vehicle, e.g., vehicle 30, 60, is inoperative, the controller 20 may be configured to generate an emergency message 54, 54′, 54″ for transmission by the communication unit 12 of the host vehicle, e.g., vehicle 30, 60. In response to an indication of an accident involving the host vehicle, e.g., vehicle 30, 60, the communication unit 12 and the controller 20 of the host vehicle, e.g., vehicle 30, 60, may be configured to receive power from an uninterruptable power supply on board the host vehicle, e.g., vehicle 30, 60, such as a main vehicle battery or a backup battery.

The communication unit 12 of any vehicle, e.g., vehicle 30, 60, may be further configured to transmit a V2X communication 50, 50′, 50″, 50′″ comprising the emergency message 54, 54′, 54″ and data indicative of the host vehicle, e.g., vehicle 30, 60. The data indicative of the host vehicle, e.g., vehicle 30, 60, may comprises data indicative of a latitude, longitude, elevation, speed, heading, acceleration, yaw rate, and/or path history of the host vehicle, e.g., vehicle 30, 60. Moreover, the communication unit 12 may comprise an on-board unit (OBU) and the V2X communication 50, 50′, 50″, 50′″ may comprise a basic safety message 52.

Moreover, the communication unit 12 of any vehicle, e.g., vehicle 32, 34, may be further configured to receive a V2X communication 50, 50′, 50″, 50′″ which may comprise an emergency message 54, 54′, 54″ transmitted by another vehicle, e.g., vehicle 30, 60. In response to receipt of such a V2X communication 50, 50′, 50″, 50′″ from another vehicle, e.g., vehicle 30, 60, the controller 20 of such a vehicle, e.g., vehicle 32, 34, may be configured to provide an alert to the driver of that vehicle, e.g., vehicle 32, 34, based on the emergency message 54, 54′, 54″ transmitted by the other vehicle, e.g., vehicle 30, 60. Such an alert may be audible, visual, or tactile in nature and may be provided in any known fashion and by any known means, such as a loudspeaker, chime, lamp, or motor, or any type of known driver assistance system which may be provided with or include a loudspeaker, chime, lamp, or motor, and which may be configured to generate, provide, and/or transmit a signal to such a device to thereby effectuate such an alert.

The controller 20 of any vehicle, e.g., vehicle 30, 60, may be further configured to generate a relay request message 56, 56′, 56″ to request that another vehicle, e.g., vehicle 32, 34, comprising a V2X communication system transmit the emergency message 54, 54′, 54″ for receipt by one or more additional vehicles, e.g., vehicle 36, 38, 40, comprising a V2X communication system. Moreover, the communication unit 12 of any vehicle, e.g., vehicle 30, 60, may be further configured to transmit a V2X communication 50′, 50″, 50′″ comprising the emergency message 54, 54′, 54″ and the relay request message 56, 56′, 56″.

Furthermore, the controller 20 of any vehicle, e.g., vehicle 30, 60, may be configured to generate propagation information for use in controlling the propagation or relaying of emergency messages 54, 54′, 54″ by other vehicles, e.g., vehicle 32, 34, 36, 38, 40. In that regard, the communication unit 12 of such a vehicle, e.g., vehicle 30, 32, 34, 60 may be further configured to transmit a V2X communication 50′″ which may comprise an emergency message 54′, 54″ and the propagation information 58, 58′. The number of relay transmissions of the emergency message 54′, 54″ by additional vehicles, e.g., vehicle 36, 38, 40, comprising a V2X communication system may be limited based on the propagation information 58, 58′. In that regard, the propagation information 58, 58′ may comprise a unique incident identification which may comprise a timestamp, global positioning system coordinates of a vehicle, and/or a vehicle identification number of a vehicle, e.g., vehicle 30, 60. Such propagation information 58, 58′ may alternatively or in addition comprise geofencing information, a propagation counter, or emergency services response information (i.e., information indicating that emergency services have responded to the accident, which information may for example be broadcast by an emergency services vehicle via a V2X communication for receipt by one or more vehicles, e.g., vehicle 30, 32, 34, 60).

Still referring to FIGS. 1-4C, the present disclosure also provides a method for transmission of an emergency message from a host vehicle including a V2X communication system. The method may comprise generating at the host vehicle, e.g., vehicle 30, 60, an indication of an accident involving the host vehicle, e.g., vehicle 30, 60, and generating at the host vehicle, e.g., vehicle 30, 60, an emergency message 54, 54′, 54″ for transmission in a V2X communication 50, 50′, 50″, 50′″ in response to the indication of an accident involving the host vehicle, e.g., vehicle 30, 60, and an indication that a cellular communication unit mounted in the host vehicle, e.g., vehicle 30, 60 is inoperative. In that regard, the method may further comprise providing, in response to the indication of an accident involving the host vehicle, e.g., vehicle 30, 60, uninterrupted power to the V2X communication system of the host vehicle, e.g., vehicle 30, 60, such as from a main vehicle battery or a backup battery.

In that regard, generating at the host vehicle, e.g., vehicle 30, 60 an emergency message for transmission in a V2X communication 50, 50′, 50″, 50′″ may comprise generating, by a controller 20 mounted in the host vehicle, e.g., vehicle 30, 60, an emergency message 54, 54′, 54″ for transmission in a V2X communication 50, 50′, 50″, 50′″ in response to the indication of an accident involving the host vehicle, e.g., vehicle 30, 60, and an indication that a cellular communication unit mounted in the host vehicle, e.g., vehicle 30, 60, is inoperative.

The method of the present disclosure may further comprise transmitting from the host vehicle, e.g., vehicle 30, 60, a V2X communication 50, 50′, 50″, 50′″ which may comprise the emergency message 54, 54′, 54″ and data indicative of the host vehicle, e.g., vehicle 30, 60. In that regard, transmitting from the host vehicle, e.g., vehicle 30, 60, a V2X communication 50, 50′, 50″, 50′″ may comprise transmitting, by a communication unit 12 mounted in the host vehicle, e.g., vehicle 30, 60, a V2X communication 50, 50′, 50″, 50′″ comprising the emergency message 54, 54′, 54″ and data indicative of the host vehicle, e.g., vehicle 30, 60. The data indicative of the host vehicle, e.g., vehicle 30, 60, may comprise data indicative of a latitude, longitude, elevation, speed, heading, acceleration, yaw rate, and/or path history of the host vehicle, e.g., vehicle 30, 60, and may comprise a basic safety message (BSM) 52.

Referring still to FIGS. 1-4C, the method of the present disclosure may further comprise receiving at a vehicle, e.g., vehicle 32, 34, a V2X communication 50, 50′, 50″, 50′″ which may comprise an emergency message 54, 54′, 54″ transmitted by another vehicle, e.g., vehicle 30, 60, and providing, in response to receipt of the V2X communication 50, 50′, 50″, 50′″ comprising the emergency message 54, 54′, 54″, an alert message to the driver of that vehicle, e.g., vehicle 32, 34, based on the emergency message 54, 54′, 54″. In that regard, the method may further comprise generating at a vehicle, e.g., vehicle 30, 60, a relay request message 56, 56′, 56″ to request that another vehicle, e.g., vehicle 32, 34, comprising a V2X communication system relay the emergency message 54, 54′, 54″ to one or more additional vehicles, e.g., vehicle 36, 38, 40, each comprising V2X communication system. The method may still further comprise transmitting from a vehicle, e.g., vehicle 30, 60, a V2X communication 50′, 50″, 50′″ which may comprise the emergency message 54, 54′, 54″ and the relay request message 56, 56′, 56″.

Moreover, the method of the present disclosure generating propagation information 58, 58′ at a vehicle, e.g., vehicle 30, 60, for use in controlling the propagation or relaying of emergency messages 54, 54′, 54″ by other vehicles, e.g., vehicle 32, 34, 36, 38, 40. In that regard, the method may further comprise transmitting a V2X communication 50′″ which may comprise an emergency message 54′, 54″ and the propagation information 58, 58′. Here again, the number of relay transmissions of the emergency message 54′, 54″ by additional vehicles, e.g., vehicle 36, 38, 40, comprising a V2X communication system may be limited based on the propagation information 58, 58′. Once again, the propagation information 58, 58′ may comprise a unique incident identification which may comprise a timestamp, global positioning system coordinates of a vehicle, and/or a vehicle identification number of a vehicle, e.g., vehicle 30, 60. Such propagation information 58, 58′ may alternatively or in addition comprise geofencing information, a propagation counter, or emergency services response information (i.e., information indicating that emergency services have responded to the accident, which information may for example be broadcast by an emergency services vehicle via a V2X communication for receipt by one or more vehicles, e.g., vehicle 30, 32, 34, 60).

As is readily apparent from the foregoing, various non-limiting embodiments of a system and method for transmission of an emergency message from a host vehicle via a V2X communication system have been described. The system and method of the present disclosure utilize V2X communications to help address, reduce, mitigate, solve, or eliminate the issues or problems described herein associated with eCall or similar systems.

While various embodiments have been illustrated and described herein, they are exemplary only and it is not intended that these embodiments illustrate and describe all those possible. Instead, the words used herein are words of description rather than limitation, and it is understood that various changes may be made to these embodiments without departing from the spirit and scope of the following claims.

What is claimed is:

1. A system for transmission of an emergency message from a host vehicle, the system comprising:
a communication unit to be mounted in the host vehicle and configured to transmit a vehicle-to-x communication comprising data indicative of the host vehicle; and
a controller to be mounted in the host vehicle and provided in communication with the communication unit wherein, in response to an indication of an accident involving the host vehicle and an indication that a cellular communication unit mounted in the host vehicle is inoperative, the controller is configured to generate an emergency message for transmission by the communication unit.

2. The system of claim 1 wherein the communication unit is further configured to transmit a vehicle-to-x communication comprising the emergency message and data indicative of the host vehicle.

3. The system of claim 1 wherein the data indicative of the host vehicle comprises data indicative of a latitude, longitude, elevation, speed, heading, acceleration, yaw rate, and/or path history of the host vehicle.

4. The system of claim 3 wherein the communication unit comprises an on-board unit and the vehicle-to-x communication comprises a basic safety message.

5. The system of claim 1 wherein the communication unit is further configured to receive a vehicle-to-x communication comprising another emergency message transmitted by a second vehicle and wherein, in response, the controller is further configured to provide an alert to the driver of the host vehicle based on the another emergency message.

6. The system of claim 1 wherein the controller is further configured to generate a relay request message to request that a second vehicle comprising a vehicle-to-x communication system transmit the emergency message for receipt by an additional vehicle comprising a vehicle-to-x communication system and wherein the communication unit is further configured to transmit a vehicle-to-x communication comprising the emergency message and the relay request message.

7. The system of claim 6 wherein the controller is further configured to generate propagation information, wherein the communication unit is further configured to transmit a vehicle-to-x communication comprising the emergency message and the propagation information, and wherein relay transmissions of the emergency message by the second vehicle comprising a vehicle-to-x communication system are limited based on the propagation information.

8. The system of claim 7 wherein the propagation information comprises:
a unique incident identification comprising a timestamp, global positioning system coordinates, and/or a vehicle identification number;
geofencing information;
a propagation counter; or
emergency services response information.

9. The system of claim 1 wherein, in response to the indication of an accident involving the host vehicle, the communication unit and the controller are further configured to receive power from an uninterruptable power supply on board the host vehicle.

10. A method for transmission of an emergency message from a host vehicle including a vehicle-to-x communication system, the method comprising:
generating at the host vehicle an indication of an accident involving the host vehicle; and
generating at the host vehicle an emergency message for transmission in a vehicle-to-x communication in response to the indication of an accident involving the host vehicle and an indication that a cellular communication unit mounted in the host vehicle is inoperative.

11. The method of claim 10 wherein generating at the host vehicle an emergency message for transmission in a vehicle-to-x communication comprises generating, by a controller mounted in the host vehicle, an emergency message for transmission in a vehicle-to-x communication in response to the indication of an accident involving the host vehicle and an indication that a cellular communication unit mounted in the host vehicle is inoperative.

12. The method of claim 10 further comprising transmitting from the host vehicle a vehicle-to-x communication comprising the emergency message and data indicative of the host vehicle.

13. The method of claim 12 wherein transmitting from the host vehicle a vehicle-to-x communication comprises transmitting, by a communication unit mounted in the host vehicle, a vehicle-to-x communication comprising the emergency message and data indicative of the host vehicle.

14. The method of claim 13 wherein the vehicle-to-x communication comprises a basic safety message.

15. The method of claim 10 wherein the data indicative of the host vehicle comprises data indicative of a latitude, longitude, elevation, speed, heading, acceleration, yaw rate, and/or path history of the host vehicle.

16. The method of claim 12 further comprising:
receiving at a second vehicle the vehicle-to-x communication comprising the emergency message transmitted by the host vehicle; and
providing, in response to receipt at the second vehicle of the vehicle-to-x communication comprising the emergency message, an alert message to the driver of the second vehicle based on the emergency message.

17. The method of claim 10 further comprising:
generating at the host vehicle a relay request message to request that a second vehicle comprising a vehicle-to-x communication system relay the emergency message to additional vehicles each comprising a vehicle-to-x communication system; and
transmitting from the host vehicle a vehicle-to-x communication comprising the emergency message and the relay request message.

18. The method of claim 17 further comprising:
generating propagation information at the host vehicle; and
transmitting a vehicle-to-x communication comprising the emergency message and the propagation information, wherein relay transmissions of the emergency message by the second vehicle comprising a vehicle-to-x communication system are limited based on the propagation information.

19. The method of claim 18 wherein the propagation information comprises:
a unique incident identification comprising a timestamp, global positioning system coordinates, and/or a vehicle identification number;
geofencing information;
a propagation counter; or
emergency services response information.

20. The method of claim 10 further comprising providing uninterrupted power to the vehicle-to-x communication system of the host vehicle in response to the indication of an accident involving the host vehicle.
